(19) United States
(12) Patent Application Publication
(10) Pub. No.: US 2015/0135164 A1
(43) Pub. Date: May 14, 2015

(54) Integrated Software Testing Management

(71) Applicant: Halliburton Energy Services, Inc., Houston, TX (US)

(72) Inventors: Cheronda Simmons Bright, Richmond, TX (US); Moises Zanabria, Katy, TX (US); Perna Pierre, Sugar Land, TX (US)

(73) Assignee: Halliburton Energy Services, Inc., Houston, TX (US)

(21) Appl. No.: 14/075,060

(22) Filed: Nov. 8, 2013

(51) Int. Cl. G06F 11/36

(52) U.S. Cl. CPC G06F 11/3672
USPC 717/124

(57) ABSTRACT

The present disclosure relates to an integrated software testing management workflow for associating manual test cases with automated test cases. One example method includes identifying a manual test program associated with a software application, the manual test program including instructions operable to perform a test operation on the software application; identifying an automated test program associated with the software application, the automated test program including instructions operable to perform the test operation from the manual test program on the software application; associating the manual test program with the automated test program; executing the automated test program to produce an automated test program result; and presenting a report including the automated test program result, the report indicating that the automated test program result is associated with the manual test program.

### BACKGROUND

The present disclosure relates to an integrated software testing management workflow for associating manual test cases with automated test cases.

In software development, software applications are often tested using test programs that, when executed, perform one or more tests on the software application. In some cases, these test programs may be run after the software application has been changed in order to verify that the application still functions as expected. Software developers may author these test programs as they develop a software application as part of a software development process.

### DESCRIPTION OF DRAWINGS

FIG. 1 is a diagram of an example computing system for implementing the techniques described herein.

FIG. 2 is an example system showing an interaction between a manual testing system and an automated testing system.

FIG. 3 is an example system for running automated test cases and associating them with manual test cases.

FIG. 4 is a flow chart illustrating an example method for associating manual test cases with automated test cases.

Like reference symbols in the various drawings indicate like elements.

### DETAILED DESCRIPTION

The present disclosure describes concepts related to an integrated software testing management workflow for associating manual test cases with automated test cases.

Software testing processes may involve allowing developers, testing engineers, or other individuals to specify test cases associated with a software application. In some implementations, the manual test cases may be specified in a test management system, which may be integrated into a development environment used for developing the software application.

A manual test case may include programming instructions operable to execute a predetermined test routine against the software application. In operation, a manual test case may include instructions operable to provide the software application with a predetermined input, and inspect the output produced by the software application in response to the input. The manual test case may then compare this output with a set of expected outputs. If the produced output matches one of the expected outputs, the manual test case may determine that the software application is behaving as expected for this particular case. If the produced output does not match, the manual test case may determine that the software application is not behaving as expected for this particular case, and may provide an indication that this case has failed.

In some cases, manual test cases specified by developers, testing engineers, and other individuals may be collected and converted into automated test cases to be run as part of an automated test battery. Such an automated test battery may be executed by an automated testing system. The automated testing system may be triggered programmatically, such as in response to a request to build the software application. The automated testing system may also be invoked from a software application used to develop the manual test cases. In some implementations, the automated test cases may be produced based on the manual test cases. However, when the results of the automated test cases are produced, it may be difficult for a developer, a testing engineer, or another individual to determine which manual test case corresponds to an automated test case in the produced report. This can make it difficult to determine which portions of the software application have been verified by the automated test cases in which portions have been identified as having problems.

Accordingly, the present disclosure describes techniques for associating manual test cases with automated test cases, and producing an integrated report after the execution of the automated test cases. One example method includes identifying a manual test program associated with a software application. The manual test program may be configured to perform a test operation on the software application. An automated test program is then identified. The automated test program may include instructions operable to perform the same test operation as the manual test program. The manual test program may be associated with the automated test program, such as, for example, through a common identifier assigned to the programs. The automated test program may then be executed to produce automated test program results. A report may then be presented including the automated test program result. The report may indicate that the automated test program result is associated with the manual test program.

The techniques presented herein may provide several advantages. By associating the manual test programs with the automated test programs, developers, testing engineers, and other individuals may view testing results in terms of the manual test programs they have created, making it easier for them to determine the testing status of the software application. In addition, the workflow described herein may provide greater integration and increased efficiency over previous techniques.

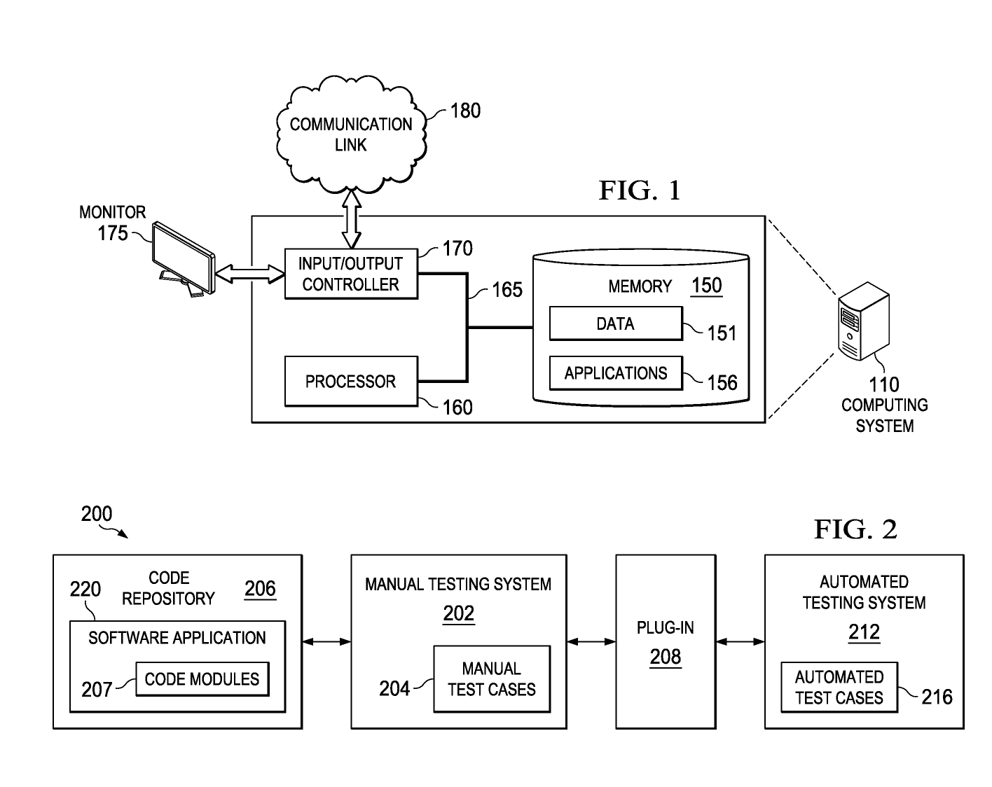

FIG. 1 is a diagram of the example computing system 110 for implementing the techniques described herein. The example computing system 110 includes a processor 160, a memory 150, and input/output controllers 170 communicably coupled by a bus 165. The memory can include, for example, a random access memory (RAM), a storage device (e.g., a writable read-only memory (ROM) or others), a hard disk, or another type of storage medium. The computing system 110 can be preprogrammed or it can be programmed (and reprogrammed) by loading a program from another source (e.g., from a CD-ROM, from another computer device through a data network, or in another manner). The input/output controller 170 is coupled to input/output devices (e.g., a monitor 175, a mouse, a keyboard, or other input/output devices) and to a communication link 180. The input/output devices receive and transmit data in analog or digital form over communication links such as a serial link, a wireless link (e.g., infrared, radio frequency, or others), a parallel link, or another type of link.

The communication link 180 can include any type of communication channel, connector, data communication network, or other link. For example, the communication link 180 can include a wireless or a wired network, a Local Area Network (LAN), a Wide Area Network (WAN), a private network, a public network (such as the Internet), a WiFi network, a network that includes a satellite link, or another type of data communication network. In some implementations, data associated with manual or automated test cases may be received at the computing system 110 via the communication link 180.

The memory 150 can store instructions (e.g., computer code) associated with an operating system, computer applications, and other resources. The memory 150 can also store application data and data objects that can be interpreted by one or more applications or virtual machines running on the computing system 110. As shown in FIG. 1, the example memory 150 includes data 151 and applications 156.

In some implementations, the data 151 stored in the memory 150 may include test cases associated with a software application and/or with code modules associated with the software application.

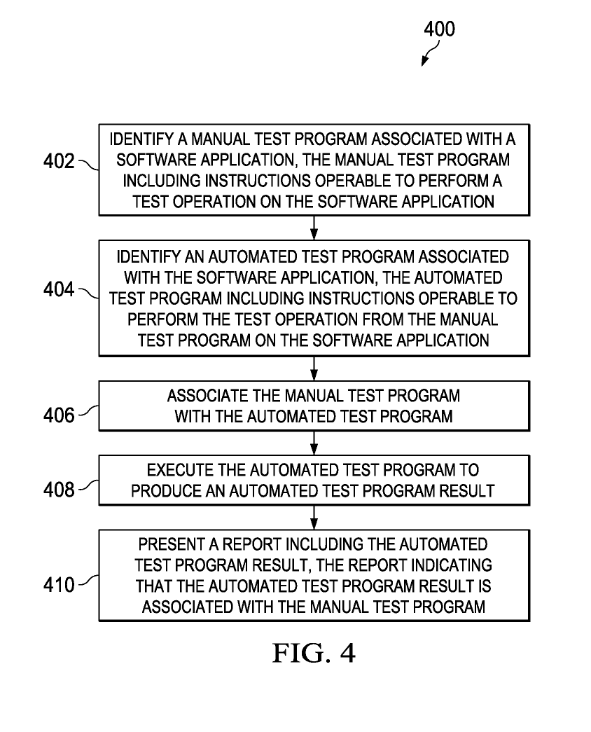

The applications 156 can include software applications, scripts, programs, functions, executables, or other modules that are interpreted or executed by the processor 160. Such applications may include machine-readable instructions for performing one or more of the operations represented in FIG. 4. The applications 156 can obtain input data from the memory 150, from another local source, or from one or more remote sources (e.g., via the communication link 180). The applications 156 can generate output data and store the output data in the memory 150, in another local medium, or in one or more remote devices (e.g., by sending the output data via the communication link 180).

The processor 160 can execute instructions, for example, to generate output data based on data inputs. For example, the processor 160 can run the applications 156 by executing or interpreting the software, scripts, programs, functions, executables, or other modules contained in the applications 156. The processor 160 may perform one or more of the operations represented in FIG. 4. The input data received by the processor 160 or the output data generated by the processor 160 can include any of the data 151.

FIG. 2 is an example system 200 showing an interaction between a manual testing system 202 and an automated testing system 212. In some implementations, the manual testing system 202 may be implemented in software, hardware, or a combination of the two. In some cases, the manual testing system 202 may be a commercial software product, such as, for example, MICROSOFT Test Manager, MICROSOFT Visual Studio, and/or other software products.

The manual testing system 202 may be operable to allow software developers to specify one or more manual test cases 204 associated with software programs. For example, a software developer may interact with the manual testing system 202 to create a manual test case 204 that will present a software application with a given input and observe the output produced by the software application response to the input. The manual test case 204 may compare the output generated by the software application to a set of expected outputs, and determine a status of the software application based on the comparison. For example, if the output produced by the software application does not match the expected output, the test case may note the status of the software application test as failed. In some implementations, the manual test cases 204 may include programming instructions operable to perform the test case. In some implementations, the manual test cases 204 may perform additional testing procedures.

The manual testing system 202 is connected to a code repository 206 storing code modules 207. In some implementations, the code repository 206 may be a repository configured to store software code. The code repository 206 may allow software developers to check out and commit versions of the code modules. Code repository 206 may integrate with the manual testing system 202, such as by calling test cases associated with a particular code module 207 when the module is checked in to the code repository 206. In some implementations, the code repository 206 may be a software repository system, such as, for example, Concurrent Version System (CVS), Subversion, Bazaar, MICROSOFT Team Foundation Server, or another software repository system.

As shown, the system 200 also includes a plug-in 208. The plug-in 208 provides an interface between the manual testing system 202 and an automated testing system 212, described below. In some cases, the plug-in 208 may be a software program executing on a separate server from the manual testing system 202 and the automated testing system 212. The plug-in 208 may also be co-located with either of the testing systems. As shown, the plug-in 208 is operable to associate the manual test cases 204 with corresponding automated test cases 216 in the automated testing system 212. In some implementations, the association may be performed by assigning a common unique identifier to a manual test case into a corresponding automated test case. In some cases, when the automated testing system 212 runs the automated test cases 216, the results are passed through the plug-in 208, which associates the results of the automated test cases with their corresponding manual test cases. For example, if an automated test case failed, the plug-in 208 may present a report to the manual testing system 202 indicating that the corresponding manual test case failed.

The system 200 also includes an automated testing system 212. In some implementations, the automated testing system 212 may be an external system from the manual testing system 202 and the code repository 206. The automated testing system 212 may be operable to run one or more automated test cases 216. In some implementations, the automated test cases 216 may be software programs operable to test various features of a software application 220 that includes the code modules 207 tested by the manual test cases 204. In some implementations, the automated testing system 212 may execute the automated test cases 216 as part of a development workflow. For example, the automated testing system 212 may execute the automated test cases 216 in response to the software application 220 being built. In some implementations, the automated testing system 212 may be a commercial software product, such as, for example, LogiGear Test Architect, or another software product.

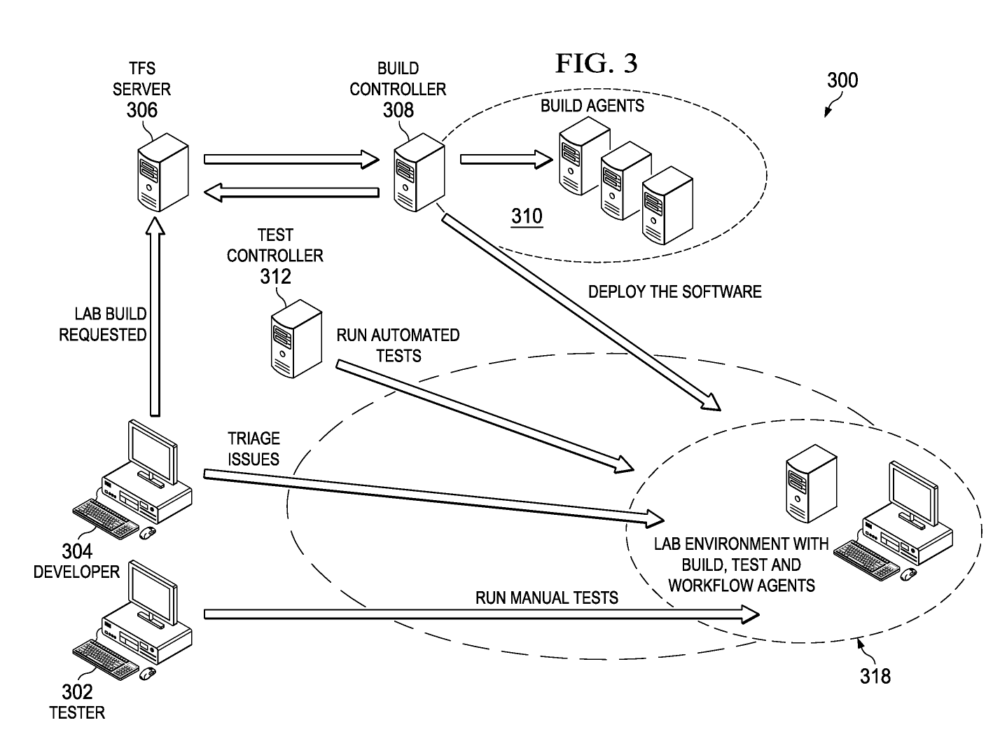

FIG. 3 is an example system 300 for running automated test cases and associating them with manual test cases. The system 300 may be operable to perform a build process on a software application, the build process including building, deploying, and testing the software application.

As shown, system 300 includes a testing computer 302. The testing computer 302 may allow a testing engineer to run manual test cases on a lab environment 318 (described below). In some implementations, the manual test cases may be similar or identical to the manual test cases 204 described relative to FIG. 2.

The system 300 also includes a developer computer 304. The developer computer 304 allows a software engineer to triage or investigate issues identified during the testing process. For example, the developer computer 304 may interact with the lab environment 318 to allow the software engineer to inspect a running software application under test, and diagnose issues.

The developer computer 304 may be operable to send a build request to a repository 306, the build request specifying a software application to be built. The repository 306 may store code modules associated with the software application, such as the code modules 207 and software application 220 described relative to FIG. 2. The repository 306 may interact with a build controller 308 to build the software application requested by the developer computer 304. The build controller 308 may interact with one or more build agents 310 to build the requested software application. In some implementations, the repository 306 may send the code modules associated with the requested software application to the build controller 308 along with instructions on how to build the software application from the code modules. The build controller 308 may instruct each of the build agents to build a portion of the software application. For example, the build controller may assign a code module to each of the build agents to compile, and may perform a linking step on the compiled code modules to produce the software application.

The build controller 308 may deploy the built software application to a lab environment 318. In some implementations, the lab environment 318 is a dedicated server or set of servers for testing the software application. In some cases, lab environment 318 is a virtual server or set of virtual servers for testing the software application. The build controller 308 may interact with a program managing the virtual server or set of virtual servers, such as a hypervisor, in order to deploy the software application.

The system 300 also includes a test controller 312. In some implementations, the test controller 312 may be operable to run automated tests on the software application running on the lab environment 318. The test controller 312 may run the automated tests by executing the software code associated with the automated tests on the lab environment 318. The test controller 312 may receive results from the automated tests indicating a status associated with each test. In some implementations, the test controller may associate these automated test results with corresponding manual test cases, and provide a report indicating the status of the manual test cases, such as to the test computer or the developer computer. In some implementations, this association is performed by a plug-in, such as the plug-in 208 shown in FIG. 2. The plug-in may execute on the test controller 312, the developer computer 304, the test computer 302, or on another component of the system 300.

FIG. 4 is a flow chart illustrating an example method for associating manual test cases with automated test cases.

At 402, a manual test program associated with the software application is identified, the manual test program including instructions operable to perform a test operation on the software application. In some implementations, identifying the manual test program may include retrieving the manual test program from a code repository. Identifying the manual test program may also include receiving a definition of the manual test program from a software engineer.

At 404, an automated test program associated with the software application is identified, the automated test program including instructions operable to perform the test operation from the manual test program on the software application without human interaction. At 406, the manual test program is associated with the automated test program. In some implementations, associating the manual test program with the automated test program includes associating a unique identifier with the manual test program, and associating the unique identifier for the manual test program with the automated test program.

At 408, the automated test program is executed to produce an automated test program result. In some implementations, executing the automated test program may include executing the automated test program with the software application and allowing it to interact with the application, such as by providing the software application with input and observing the output produced.

At 410, a report including the automated test program result is presented, the report indicating that the automated test program result is associated with the manual test program. In some implementations, the report may be in a human-readable format, such as a MICROSOFT WORD document, a MICROSOFT EXCEL spreadsheet, an ADOBE Portable Document Format (PDF) document, or another format. The report may also be produced in a machine-readable format such as, for example, Extensible Markup Language (XML), rows in a database table, Hypertext Markup Language (HTML), or another format.

In some implementations, the method 400 includes executing the manual test program by a first system, and executing the automated test program by a second system different than the first system. In some cases, the manual test program is initiated by a human, and the automated test program is initiated automatically, such as in response to the software application being built. The method 400 may also include automatically deploying the software application to a testing environment prior to executing the automated test program, and automatically building the software application prior to deploying the software application.

In some cases, the manual test program may be identified using a manual test software application. For example, the manual test program may be defined using an editor or development tool, such as, for example, MICROSOFT Test Manager, MICROSOFT Visual Studio, or other tools. In some cases, executing the automated test program includes invoking the automated test program from the manual test software application.

Notably, in certain instances, one or more of the above operations can be performed in a different order and/or omitted.

Some embodiments of subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks , and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A client and server are generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). The relationship of client and server arises by virtue of computer programs running on the respective computers and having a client-server relationship to each other.

In some aspects, some or all of the features described here can be combined or implemented separately in one or more software programs for digitally characterizing and simulating wormhole structures. The software can be implemented as a computer program product, an installed application, a client-server application, an Internet application, or any other suitable type of software

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications can be made. Accordingly, other embodiments are within the scope of the following claims.

1. A computer-implemented method executed by one or more processors, the method comprising:
identifying a manual test program associated with a software application, the manual test program including instructions operable to perform a test operation on the software application;
identifying an automated test program associated with the software application, the automated test program including instructions operable to perform the test operation from the manual test program on the software application;
associating the manual test program with the automated test program;
executing the automated test program to produce an automated test program result; and
presenting a report including the automated test program result, the report indicating that the automated test program result is associated with the manual test program.

2. The method of claim 1, wherein associating the manual test program with the automated test program further comprises:
associating a unique identifier with the manual test program;
associating the unique identifier for the manual test program with the automated test program.

3. The method of claim 1, further comprising executing the manual test program by a first system, and wherein executing the automated test program is performed by a second system different than the first system.

4. The method of claim 3, wherein the manual test program is executed by a human, and the automated test program is executed automatically.

5. The method of claim 1, further comprising:
automatically deploying the software application to a testing environment prior to executing the automated test program.

6. The method of claim 1, further comprising:
automatically building the software application prior to deploying the software application.

7. The method of claim 1, further comprising:
deploying the software application on a virtual server; and
executing the automated test case on the virtual server to test the software application.

8. The method of claim 1, wherein the automated test case is included in a test battery that is automatically invoked in response to building the software application.

9. The method of claim 1, wherein the manual test program is identified using a manual test software application, and executing the automated test program includes invoking the automated test program from the manual test software application.

10. A non-transitory, computer-readable medium storing instructions operable when executed to cause at least one processor to perform operations comprising:
identifying a manual test program associated with a software application, the manual test program including instructions operable to perform a test operation on the software application;
identifying an automated test program associated with the software application, the automated test program including instructions operable to perform the test operation from the manual test program on the software application;
associating the manual test program with the automated test program;
executing the automated test program to produce an automated test program result; and
presenting a report including the automated test program result, the report indicating that the automated test program result is associated with the manual test program.

11. The computer-readable medium of claim 10, wherein associating the manual test program with the automated test program further comprises:
associating a unique identifier with the manual test program;
associating the unique identifier for the manual test program with the automated test program.

12. The computer-readable medium of claim 10, the operations further comprising executing the manual test program by a first system, and wherein executing the automated test program is performed by a second system different than the first system.

13. The computer-readable medium of claim 12, wherein the manual test program is executed by a human, and the automated test program is executed automatically.

14. The computer-readable medium of claim 10, the operations further comprising:
automatically deploying the software application to a testing environment prior to executing the automated test program.

15. The computer-readable medium of claim 10, the operations further comprising:
automatically building the software application prior to deploying the software application.

16. The computer-readable medium of claim 10, the operations further comprising:
deploying the software application on a virtual server; and
executing the automated test case on the virtual server to test the software application.

17. The computer-readable medium of claim 10, wherein the automated test case is included in a test battery that is automatically invoked in response to building the software application.

18. The computer-readable medium of claim 10, wherein the manual test program is identified using a manual test software application, and executing the automated test program includes invoking the automated test program from the manual test software application.

19. A system comprising:
memory for storing data; and
one or more processors operable to perform operations comprising:
identifying a manual test program associated with a software application, the manual test program including instructions operable to perform a test operation on the software application;
identifying an automated test program associated with the software application, the automated test program including instructions operable to perform the test operation from the manual test program on the software application;
associating the manual test program with the automated test program;
executing the automated test program to produce an automated test program result; and
presenting a report including the automated test program result, the report indicating that the automated test program result is associated with the manual test program.

20. The system of claim 19, wherein associating the manual test program with the automated test program further comprises:
associating a unique identifier with the manual test program;
associating the unique identifier for the manual test program with the automated test program.
